(19) United States
(12) Patent Application Publication
(10) Pub. No.: US 2017/0114864 A1
(43) Pub. Date: Apr. 27, 2017

(54) MONODIRECTIONALLY TORQUE-TRANSMITTING TOOTHED GEARING

(71) Applicant: Mario Antonio MORSELLI, Modena (MO) (IT)

(72) Inventor: Mario Antonio MORSELLI, Modena (MO) (IT)

(21) Appl. No.: 15/318,886

(22) PCT Filed: Jun. 16, 2015
(86) PCT No.: PCT/IB2015/054546

§ 371 Date: Dec. 14, 2016

(30) Foreign Application Priority Data
Jun. 17, 2014 (IT) MI2014A001093

(51) Int. Cl. F16H 1/00; F16H 55/08

(52) U.S. Cl. CPC F16H 1/003; F16H 55/0806

(57) ABSTRACT

A gear transmission including: a plurality of gear wheels having a different diameter meshing with each other, at least one first driving gear wheel activated in rotation about its own axis, and at least one second driven gear wheel meshing with the first gear wheel, teeth being asymmetrical, with active sides conjugate with one another inactive sides of the teeth of the wheels not being conjugated with one another, and the inactive side is configured so that the radius passing by a tip of the teeth is substantially tangent to the inactive side or intersects the inactive side.

The present invention concerns a gear transmission device, with unidirectional operation, which has high efficiency, in particular concerning the power which is suitable for transmitting, for the same gear size, for duration and reliability, in addition to the other aspects that have substantial advantages with respect to the prior art.

Gear transmission devices of this type are typically applied for connecting rotating shafts machines that generate mechanical power to user machines such as electrical power generating machines.

In these mechanical groups the reliability of the mechanical transmission is particularly critical, mechanical transmission which must very often comprise a gear transmission to adapt the speed of the machine operating as a motor or mechanical power generator to the speed required by the machine operating as mechanical power user.

These transmission gears are required to operate as reduction gears, typically in the case in which they are used having a high speed gas turbine as a motor, or rather as overgears if the motor is relatively slow, such as in the case in which they are actuated by wind turbines.

A repairing or replacement operation of the gear transmission requires the stop of the entire group for relatively long periods of time, and therefore leads to a considerable economic damage in addition to the transmission gear replacement or repair costs.

Such a problem is particularly important in wind turbines that actuate electric power generators. In addition to the above cited problems there is also the difficulty in reaching the transmission gears arranged at the top of towers.

The overgears transmission gears in wind turbines suffer from the problem of disadvantageously requiring frequent maintenance, even for the fact that the transmission gears must be relatively light and have low bulk, whilst requiring great regularity in the transmission of movement, and it has been found that surface damages of the active sides of the teeth of the gears occur with an undesired frequency, damages that are so common that specialised companies have been founded for repairing the active sides of these expensive gears.

In order to make these gears reliable and sufficiently durable from this point of view, the person skilled in the art, generally, considers that the first parameter that is optimised and limited is the Hertz pressure.

The known Wohler curve tells us that the duration of the transmission operation is lengthened by decreasing the load on the contact face between the teeth engaged, leading to an undefined duration after the so-called “elbow” present in this curve.

However, this curve (both in the version ISO 6336 and in the version ALMA), after the elbow, has a further inclination indicating that in some cases a damage occurs also for very high number of cycles, which were once considered “safe” if they were obtained, meaning that further damage of the driving surfaces of the teeth were to be excluded.

According to such teachings of the prior art, there can still be surface damage even if a gear has reached a billion cycles. It is hypothesised that this type of damages are related to the surface roughness, to the impurities of the lubricant, to the application modalities of the load and in general to all the factors that trigger local damage that then evolves into the surface damage that is generally known as “pitting”, such a phenomenon typically originating from stress.

It is also known that lubricants play a very important role in the surface phenomena.

It is of course true that the last generation additives EP and plasticising additives have considerable advantages, as well as another theory is known that teaches how a greater thickness of the ElastoHydroDynamic (EHD) oil film increases the life expectancy of the gear.

In the NASA document Reference Publication 1152-AVISCOM Technical Report 84-C-15 “Gearing” from 1985, now for public use, it is shown how the useful life of the gear depends upon a factor, the value of which consists of the ratio between the thickness of the lubricating film and the mean square of the roughness. Such a factor has a limitation in the manufacturing of industrial reduction gears for obvious reasons in terms of manufacturing costs, since the roughness cannot go below industrially applicable values.

In order to increase the thickness of the EHD film one could think to increase the viscosity of the lubricant, but this provision is limited by the often low temperatures at which these devices (especially in wind turbines) must be able to start up and by the energy losses that increase with the viscosity. Moreover, these important gear devices are almost always lubricated through pumps and distributors which do not operate well at too much high viscosity. In particular, in this kind of application it occurs that the extreme variability of the atmospheric conditions causes very high temperature variations that make even more critical the problem of the viscosity optimising, as the lubricant cannot be modified as the atmospheric conditions change and, for this use, even the so called multi-grade lubricants are not suitable.

The state of the art has thus addressed the designers efforts towards the following objectives of obtaining reduction gears and overgears compact and light by:
reducing the Hertz pressure
increasing the thickness of the EHD film
obtaining surfaces with low roughness and with an advantageous profile (e.g. honing).

The state of the art has achieved satisfactory results in the attempt to obtain these parameters, in transmission gears having a traditional configuration, in a compatible manner with the production on an industrial scale and with acceptable costs.

Since it is known that the lower the Hertz pressure, the higher the reliability over time, a further purpose of the invention is to find a solution to the problem of decreasing this stress, for the same power transmitted by the gears, without increasing the bulk of the gear box and possibly reducing it, even increasing the operating time of the transmission, operating on the configuration of the gears.

In order to reduce the Hertz pressure it is necessary to increase the curvature radii of the contact surfaces, but such an increase implies that, with the other factors being the same, there is an increase in the operation pressure angle. This however clashes with the need of maintaining a high transverse coverage, which is necessary both because it also decreases the Hertz pressure, at least for part of the action segment distributing the load on more than one contact where the curvature radii are disadvantageous, and because it contributes in a fundamental manner to the regular transmission of the movement.

It should also be remembered that the irregularities of the movement induce vibrations that are greater the higher the power that is transmitted and, usually, in the generation of energy the transmission of power is very high.

In order to increase the pressure angle it is necessary to limit the height of the tooth that rapidly becomes “pointed” and therefore also the transversal coverage becomes limited.

The operating pressure angle could be increased by increasing the correction coefficient of the crown, but, since the height of the tooth cannot be increased, even this provision will lead to the same problems of limiting the coverage, decreasing the length of the action section.

Such a solution can be accepted in low-speed reduction gears, bringing the sum of the correction coefficients >0, sacrificing however the needs of high coverage in favour of the load-bearing capacity.

A variation in the increase of the pressure angle, for example from 20° to 23°, bringing to a sum of the correction coefficients >0, can improve the curvature radii, but penalising the transversal coverage, whereas it is desirable to increase the latter for the reasons illustrated above.

According to the invention, the toothing of the transmission gears can assume a configuration such as to allow increasing the pressure angle, simultaneously increasing the transversal coverage grade and considerably decreasing the load on the tooth.

According to the invention, these purposes are achieved by making a gear transmission as defined in claim 1. Further characteristics of a gear transmission according to the invention are highlighted in the dependent claims.

The characteristics and the advantages of a gear transmission according to the present invention shall become clearer from the following exemplifying and non-limiting description, with reference to the attached schematic drawings, in which:

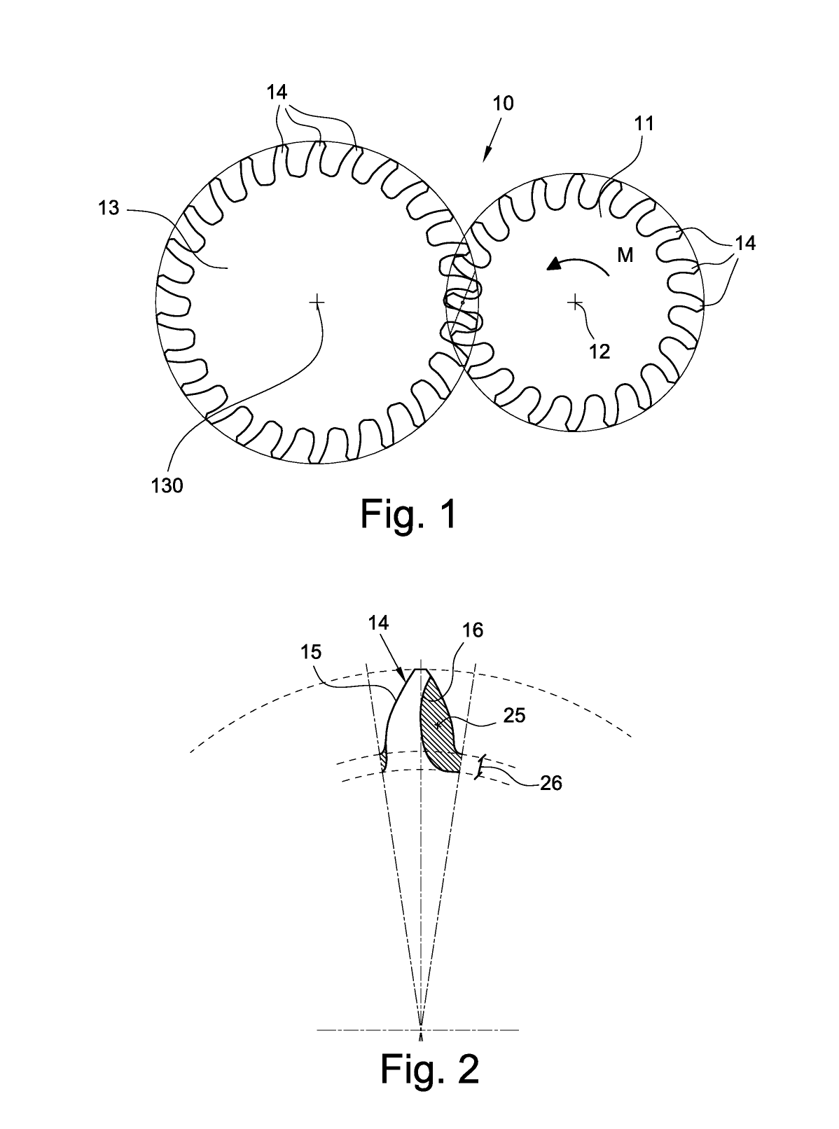

FIG. 1 shows a schematic view of a gear transmission with two toothed wheels;

FIG. 2 shows a comparison between a tooth of a known gear wheel and that of a gear wheel according to the present invention;

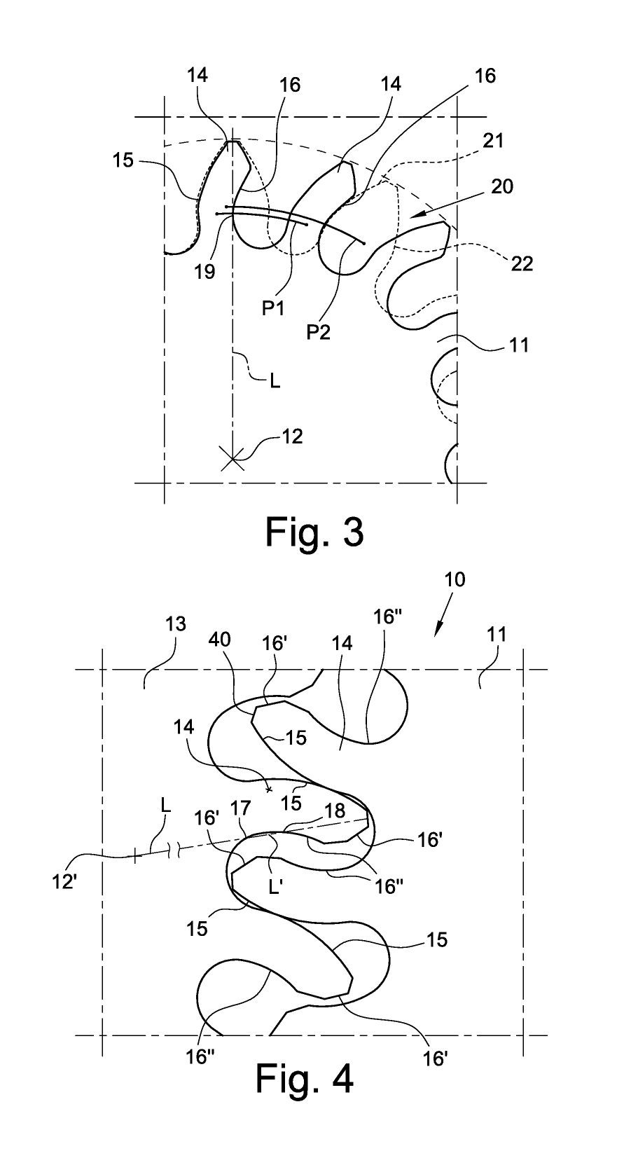

FIG. 3 shows in a schematic manner the difference in pitch between the symmetrical teeth of a wheel of a known transmission gear and those of the present invention;

FIG. 4 shows an enlarged detail of the engaging portion of two wheels according to the present invention.

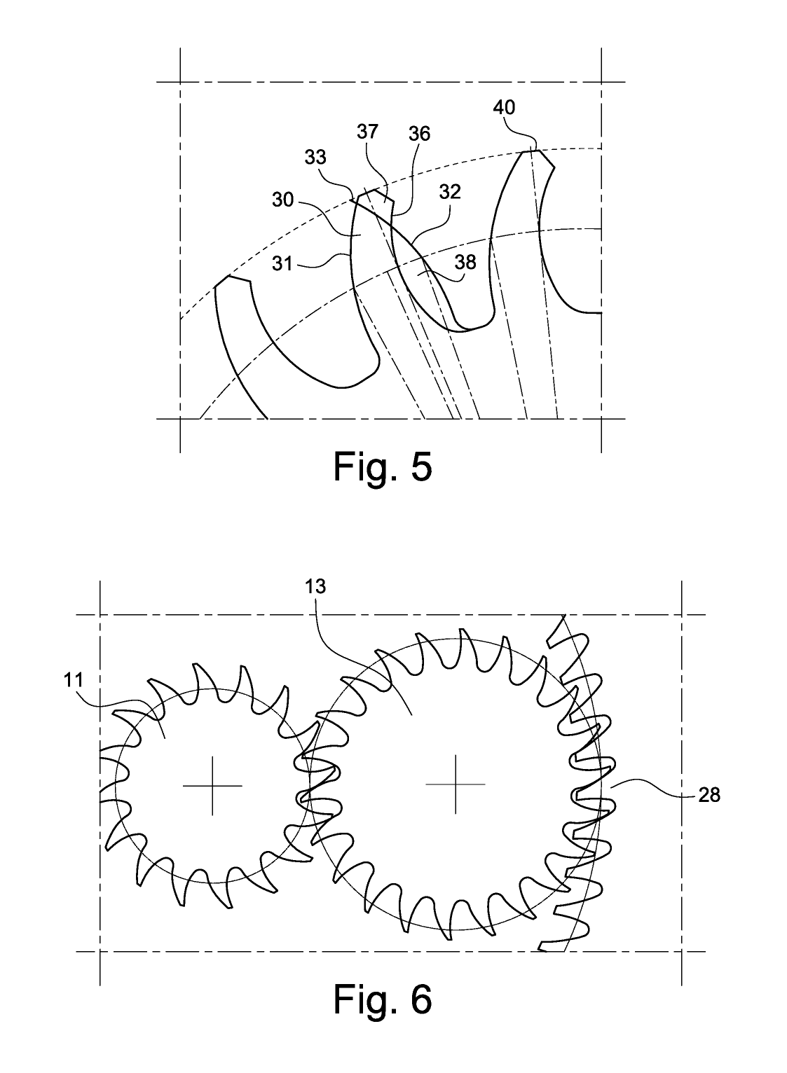

FIG. 5 shows a further comparison of a tooth of a known transmission wheel and of a tooth of a wheel according to the invention;

FIG. 6 schematically shows the engaging conditions of a transmission wheel comprising two externally toothed wheels and an internally toothed crown;

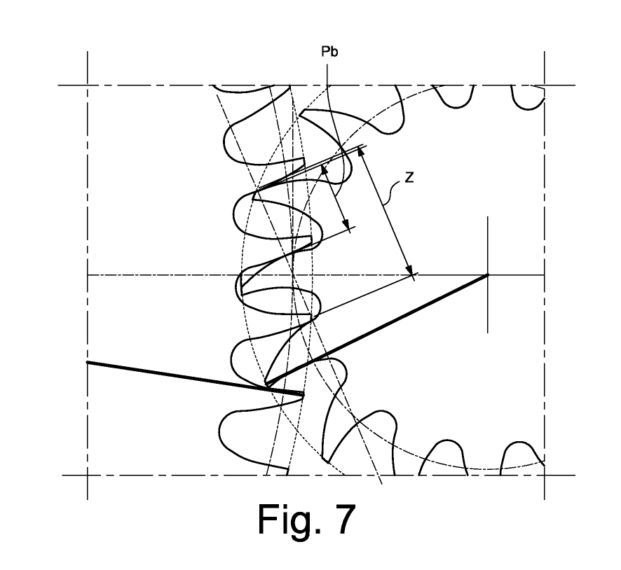

FIG. 7 shows in a schematic manner the length of the action segment that is obtained with the configuration of a toothing according to the invention.

For the purposes of the present description by gear transmission or gear transmission device we mean to indicate a mechanical power transmission device between a motor or driving member and a driven or user member, in which the movement of the first is transmitted to the second in general with a speed variation. In particular, the motor or driving member and the user or driven member are made of rotating shafts, of which, the first (motor or driving shaft) can be coupled with a machine that generates mechanical power and the second can be coupled with a machine that uses mechanical power. The user or driven member, that is, has an exit that can be connected to a machine that uses power.

The machine that uses mechanical power is, for example, a machine that generates electrical power.

As shall become clearer from the following description, the transmission according to the invention uses gears that have asymmetrical teeth, which have important technical effects on the operation characteristics.

With reference to FIG. 1, a gear transmission according to the present invention, generally indicated with reference numeral 10, is schematically shown by simply showing the gears comprised in it, each of which are mounted on a shaft and are rotatable, one shaft being provided for the entrance, and the other one for the exit of the movement, according to a general arrangement that is per se known. The shaft that is for the entrance of the movement is generally known as drive or motor shaft and it can be coupled with a machine that can generate mechanical power. The shaft for the exit of the movement is provided with an exit that can be coupled with a machine that uses mechanical power, for example, for generating electrical power. The gears of the transmission 10 comprise a motor or drive gear wheel 11, which is activated in rotation in the direction M around its own axis 12 and a driven gear wheel 13 which is set in rotation around its own axis 130 by the driving wheel 11.

The gear wheels 11 and 13 according to the invention have asymmetrical teeth, in a number greater than that of the teeth that can be provided in a wheel having the same diameter, for the same tooth height. The transmission is suitable for transmitting the movement in a single sense, and the rotation sense is identified by the arrow M.

The two gear wheels, in the transmission of the type object of the invention, have as an example a number of teeth that is equal to 20 for the drive wheel 11 and equal to 26 for the driven wheel 13.

With reference to the figure, it can be noted that the active sides 15 of the teeth 14 of each wheel 11 and 13, or rather the sides 15 which rest on the sides 15 of the teeth 14 corresponding to the wheel engaged with the first one, maintain their typical conjugated profile of the per se known type, for example involute. The opposite inactive sides 16 of the same teeth 14 on the other hand have a lowered profile, i.e. hollow as it appears in the attached figures, with respect to the configuration they would have if they were symmetrical. In particular, this lowered profile consisting of a reduction 25 of the profile of the inactive side 16 of each tooth 14 with respect to the conjugated profile of a corresponding symmetrical tooth makes the teeth 14 not only asymmetrical, but also non-conjugated with one another along the inactive sides 16 or at least along a substantial portion thereof.

Only the end and convex part of the inactive side 16 towards the head of each tooth 14 can result to be conjugated with the concave part towards, that is close to the bottom of the toothing of the counter-wheel, and it is clear from the drawing how the convex part towards the head has a length that is much smaller than the concave part towards the bottom. For this reason it can be seen how the inactive profile 16 has two separate sections, one convex 16′ and one concave 16″. The convex section has a limited length and could also have a zero length bringing the tooth to end with a sharp edge, even though a small convex section is useful both in the size control step during production and in the transmission running in step. The concave section is longer and, from the end of the convex section, it reaches the bottom with a large radius. As can be seen from the figures, the convex section 16′ of the inactive side 16 is completely outside the pitch circle, being able to be reduced tending to zero.

It can be seen from FIG. 4 how, preferably, the tooth bottom curves have curvature radii that are very wide. In the most common case in which the tooth bottom curves are trochoidal generated by screw milling or grinders machines (enveloping hobs) with a rounded head with arches of circumference, these head radii of the tool are preferably of the order of 0.5-0.7 moduli, typically 0.5, compared to usual values of around 0.2 and 0.3 moduli. This characteristic is suitable especially for a structural problem: the teeth of the invention are thinner than those of known toothing, so they must have large radii so as to reduce the notch effect and improve the resistance to bending, which is a condition necessary for operating even for high transmitted torques. Also the purely geometrical proportioning of the mesh is favourably effected by this choice.

Therefore, in general terms, the invention provides the adoption of a wheel, typically but not necessarily with straight teeth, in which such asymmetrical teeth have inactive non-conjugated sides 16 (or conjugated in the way above described, the convex section 16′ being conjugated with the concave section 16″ of the teeth of the counter-wheel, where the convex section 16′ is conjugated to the concave section 16″ of the teeth of the counter-wheel in the sense that it is capable of operating through the driving in the case of inversion of the movement, of course without the transmission of substantial torque, considering the contact surface limited area) and strongly recessed with respect to a conjugated profile.

As shown in FIG. 2, it can also be provided a further lowering or recess 26 of the groove between two successive teeth 14 both at the base of the active operating side 15 and at the base of the inactive side 16. As it is clear, such a lowered portion or recess 26 of the groove increases the height of the tooth. Making the teeth 14 asymmetrical and, more in particular, the possibility of providing a lowered portion or recess 25 of the tooth 14 along the inactive side 16, is per se already known matter.

According to the invention, the removal of the volume 25 of the inactive side 16 of the tooth 14, which is not required to be conjugated, causes a substantial reduction of the pitch between the teeth 14.

The schematic FIG. 3 shows just how thanks to the reduction 25 of the inactive side 16 of the tooth 14 the pitch P1 can be considerably reduced, without compromising the operation of the transmission, with respect to the pitch P2 provided for a known wheel for the same height of a symmetrical tooth. Having reduced the pitch there is thus an increased number of teeth and the coverage is increased in a substantial manner.

Indeed it should be considered a traditional toothing providing the formation of the maximum number of symmetrical teeth having conjugated profiles with a predetermined diameter pitch line.

This sizing of the tooth leads to a substantially pointed configuration thereof, represented in FIG. 3 by the broken line 20, where the conjugated side is indicated with reference numeral 21, which is suitable for resting on the side of the tooth of a corresponding wheel of the transmission. Reference numeral 22 shows the profile of the inactive side of the tooth 20.

Along with this tooth profile according to the state of the art, in the drawing a series of teeth 14 according to the invention are represented superimposed in a continuous line.

The profile of the conjugated side 15 of the tooth 14 consists of the profile of a tooth 14 with a height that would be too high for it to have a symmetrical profile. In case of maximum height, the profiles of the two sides would determine such a pointed tooth, if it had a symmetrical profile.

As described previously, the inactive side 16 of the toothing is made starting from the top of the conjugated profile 15, with a concave profile, recessed by removal of material.

From a geometrical point of view, the recess 25 of the inactive side 16 is carried out so that the radius L of the respective wheel 11, 13 that passes through the head 40 of the tooth is substantially tangent to the very profile of the inactive side 16 or intersecting the latter. Therefore we mean that the radius L does not strictly pass through the apex of the tooth intended as the point furthest from the centre of the wheel, but in a reasonable vicinity determined by the configuration of the head intended as an end face of the tooth itself.

In particular such a radius L can be slightly inside the inactive side 16 by a distance that is comparable to the size (i.e. the width) of the head 40 of the tooth 14, or it can be tangent in a point at the inactive side 16, or it can intersect it in two points 17, 18 thus identifying a brief section even outside the tooth 14.

This condition is shown in FIG. 4 and it further represents the difference between what occurs in the prior art, where the radius passing through the vertex of the tooth, even in the case in which there is an asymmetric toothing, is completely and substantially inside the relative tooth.

In the detail of the embodiment shown in FIG. 4, the inactive side 16 comprises a first conjugated tip section 16′ with the corresponding tooth of the facing wheel, and a second connecting section 16″ with the throat, said second connecting section being not conjugate with the corresponding tooth of the facing wheel.

Preferably such a second connecting section 16″ of the inactive side 16 has a concavity facing the same direction with respect to the driving side 15.

Even more advantageously, the second connecting section 16″ of the inactive side 16 is substantially parallel to the driving side 15.

According to such a last embodiment it could also be possible to say that the tooth 14 is actually collapsed just on the operating side 15 that in any case defines a tooth thickness that is sized so as to resist mechanical stresses that generate in use of the gear transmission, even for high pressure.

According to the invention, there is no longer the need of configuring the inactive side of the tooth according to a conjugated profile.

In such a way, a tooth according to the invention can have the active side 15 that follows the theoretical conjugated profile 31 even beyond the point 33, thus determining a greater height of the tooth.

The inactive side 16 of the tooth according to the invention will have the profile indicated with reference numeral 36, which defines a portion of tooth 37 which can be present where it would not be possible to have material of a symmetrical tooth, whereas it will be absent in the portion 38 which is allowed in a tooth with a symmetrical profile, but it is excluded to be present in the toothing according to the invention, so as to avoid interference between the meshing toothings.

In such a way the purpose of the invention of obtaining a greater compenetration of the toothing, is thus achieved that is making the gears work at smaller pitch diameters and center distance, thus reducing the operation circular pitch, to the advantage of the gear transmission bulk.

It should be noted, from the description made so far, that the tooth according to the invention with asymmetrical sides has the inactive side with a profile that is away from the conjugated profile, basically concave, although it is possible for it to be substantially rectilinear.

The “local” pressure angle of the inactive side is basically negative, to reach a maximum of around 1-2.5°.

The circular thickness of the tooth is essentially virtual: indeed, the calculation of the circular thickness, resulting from the expression pitch circumference/number of teeth/2, leads to a value that does not have an effect on the thickness of the material of the tooth (which is substantially smaller) nor on the thickness that the tooth would have, should it be completed (which would be considerably greater, even for angles with minimum pressure).

The configuration of the teeth of the gears proposed by the invention can be adopted also in gear transmissions that provide meshing couplings between an externally toothed wheel and an internally toothed crown and, in particular, in transmissions with gears of the hypocycloidal type.

FIG. 6 partially shows a gear transmission in which a wheel 11 is used with a number of 16 teeth meshing with a wheel 13 with a number of 22 teeth, which in turn meshes with a crown wheel 28 with internal toothing with a number of 58 teeth. It is clear how the tooth configuration that the invention proposes to adopt, allows also adopting, in the internally toothed crown, teeth with a smaller pitch than that which the adoption of an internally toothed crown with symmetrical teeth would involve, allowing a singularly high coverage factor. For a person skilled in the art, as shown in the attached figures, it is also completely clear that the profile of the teeth of the gear wheels of the gear transmission according to the present invention has no undercuts with sharp edges (i.e., undercuts with reentering or concave edge), which leads to obvious and known advantages in terms of the technological-productive aspect.

In such a way, according to the purposes of the invention, it is possible to increase the pressure angle, simultaneously increasing the amount of transverse coverage and considerably decreasing the load on the tooth, as can be easily understood by the scheme shown in FIG. 7 in which Pb indicates the base pitch and reference Z indicates the length of the action segment.

According to the invention there is an increase of the curvature radius of the active face of the tooth and the increase in the number of meshing teeth in the meshing of the wheels, effects that cooperate in order to increase the thickness of the lubricant film, with the advantage on the useful life of the transmission. The transmission of the present invention as it has been described and illustrated can undergo numerous modifications and variants, all covered by the same inventive concept; moreover, all the details can be replaced by technically equivalent elements. In practice, the materials used, as well as their dimensions, can be any according to the technical requirements.

The configuration of the teeth according to the invention is particularly suitable for gears with straight teeth, but it can also be adopted in gears with helicoidal teeth, in particular with a modest helical angle.

As anticipated, the advantages obtained according to the invention are achieved with the use of the gear transmission both as overgear and as reducer gear of the angular speed of the movement entrance and exit shafts.

1-13. (canceled)

14. A gear transmission comprising:
a plurality of gear wheels having a different diameter meshing with one another, including at least one first driving tie& wheel activated in rotation around its own axis and at least one second driven gear wheel meshing with the first gear wheel,
each tooth of the wheels comprising an active driving side and an inactive side, the driving side and the inactive side of each tooth being asymmetrical with respect to each other, the driving sides of the corresponding teeth of the wheels being conjugate with each other,
wherein the inactive side is configured so that the radius of the respective wheel passing through a head of each tooth is substantially tangent to the inactive side or intersecting the inactive side in two points defining a section outside the tooth.

15. A gear transmission according to claim 14, wherein the radius does not touch the inactive side as tangency with the inactive side lacks by a small distance that is comparable to a size of the head of the tooth.

16. A gear transmission according to claim 14, wherein the inactive side comprises a first tip section conjugate to a second connecting section with a throat of the tooth and a second non-conjugate section with respective sections of the inactive side of the faced tooth of a respective counter-wheel.

17. A gear transmission according to claim 16, wherein the second connecting section of the inactive side is concave and has a concavity facing a same direction with respect to the driving side.

18. A gear transmission according to claim 17, wherein the second connecting section of the inactive side is substantially parallel to the driving side.

19. A gear transmission according to claim 14, wherein the inactive side comprises a first section towards a head of the tooth, the section being convex and conjugate in the counter-wheel with a portion of a second concave section which connects, with a bottom of the tooth, a first section of the inactive side of the counter-wheel.

20. A gear transmission according to claim 14, wherein the inactive side comprises a first convex section towards the head of the tooth and a second concave section which connects the first section of the side with the bottom of the tooth, the concave section extending up to an outside of a pitch circle, with possibility of having a conjugation of the convex section of the tooth with the concave section of the counter-wheel.

21. A gear transmission according to claim 14, wherein the convex and conjugate driving side does not have a conjugate profile up to the head of the tooth, thus determining a section of profile towards the head of the tooth which is not conjugate with the profile of the counter-wheel.

22. A gear transmission according to claim 14, of hypocycloidal type.

23. A gear transmission according to claim 14, comprising a pair of externally toothed wheels of which one meshes an internally toothed crown.

24. A gear transmission according to claim 14, for transmitting mechanical power between a driving or motor shall which can be coupled with a machine for generating mechanical power and a driven shaft provided with an exit end that can be coupled with a machine using mechanical power.

25. A speed reduction gear or overgear comprising a gear transmission according to claim 14.
